(19) United States
(12) Patent Application Publication
(10) Pub. No.: US 2019/0011654 A1
(43) Pub. Date: Jan. 10, 2019

(54) MOUNTING HOLDER AND METHOD OF PACKAGING FIBER OPTIC MODULE USING THE SAME

(71) Applicant: ORANGETEK CORPORATION, Changhua County (TW)

(72) Inventors: Chun-Chieh CHEN, Changhua County (TW); Chao-Hui KUO, Changhua County (TW)

(21) Appl. No.: 15/645,256

(22) Filed: Jul. 10, 2017

(51) Int. Cl. G02B 6/42

(52) U.S. Cl. CPC G02B 6/4256; G02B 6/4295; G02B 6/4206; G02B 6/428

(57) ABSTRACT

A method of packaging a fiber optic module comprising steps of: connecting a fiber optic connector with a mounting holder; fixing the mounting holder on a circuit board; mounting a photoelectric array element on the circuit board; and connecting a lens element with the mounting holder. The mounting holder includes a body, an accommodation trench, multiple orifices, two protrusions, and two first fixing holes. The fiber optic connector includes multiple optical fiber cables, and glue is fed into the accommodation trench. The photoelectric array element is mounted on the circuit board. The lens element includes two slots and two positioning columns, wherein the two slots respectively accommodate the two protrusions of the mounting holder, and the two positioning columns insert into the two first fixing holes of the mounting holder respectively.

### FIELD OF THE INVENTION

The present invention relates to optical fiber equipment, and more particularly to a mounting holder and a method of packing a fiber optic module using the mounting holder.

### BACKGROUND OF THE INVENTION

A conventional fiber optic module is packaged in an active coupling manner or in a passive coupling manner. For the active coupling manner, a coupler is required, while for the passive coupling manner, images of light emitting elements of a camera and an optical lens module are integrated so as to obtain preferred coupling position. However, required coupling equipment is expensive and its coupling process is complicated. In addition, after obtaining the preferred coupling position, UV glue is employed to connect the light emitting elements, the optical lens module, and multiple optical fiber cables together, but an offset error occurs to have poor coupling effect.

The present invention has arisen to mitigate and/or obviate the afore-described disadvantages.

### SUMMARY OF THE INVENTION

The primary objective of the present invention is to provide a mounting holder and a method of packing a fiber optic module using the mounting holder which reduces packaging cost and time.

To obtain the above objective, a mounting holder provided by the present invention contains: a body, an accommodation trench defined on a top of the body, multiple orifices arranged on a first peripheral side of the body and communicating with the accommodation trench.

Preferably, the body has two protrusions extending outward from two ends of the first peripheral side thereof respectively and adjacent to a bottom of the body, and two first fixing holes are defined on the two protrusions respectively.

Preferably, the body further has two first contacting faces formed on two opposite second peripheral sides thereof individually, and at least one of the two first contacting faces decreasingly tilts from its top to its bottom.

Preferably, the two first contacting faces tilts, and each of the two first contacting faces decreasingly tilts from its top to its bottom.

Furthermore, a method of packaging a fiber optic module provided by the present invention contains steps of:

connecting a fiber optic connector with a mounting holder, wherein the mounting holder includes a body, an accommodation trench defined on a top of the body, multiple orifices arranged on a first peripheral side of the body and communicating with the accommodation trench, two protrusions extending outward from two ends of the first peripheral side of the body respectively and adjacent to a bottom of the body, and two first fixing holes defined on the two protrusions respectively, the fiber optic connector includes multiple optical fiber cables mounted on one end thereof and accommodated in the multiple orifices respectively via the accommodation trench of the mounting holder, and a glue is fed into the accommodation trench so as to fix the multiple optical fiber cables with the mounting holder, wherein one end of each of the multiple optical fiber cables extends out of the mounting holder;

fixing the mounting holder on a circuit board;

mounting a photoelectric array element on the circuit board, wherein the photoelectric array element is mounted on the circuit board opposite to the mounting holder; and

connecting a lens element with the mounting holder, wherein the lens element includes two slots respectively formed on two sides thereof, and the lens element includes two positioning columns extending out of the two slots respectively, the two slots respectively accommodate the two protrusions of the mounting holder, and the two positioning columns insert into the two first fixing holes of the mounting holder respectively.

Preferably, the glue is UV glue, and when the glue is fed in the accommodation trench, it is irritated by UV lights so as to solidify and to secure the multiple optical fiber cables in the accommodation trench.

Preferably, the circuit board includes two second fixing holes corresponding to the two first fixing holes respectively so as to fix the mounting holder on the circuit board.

Preferably, the photoelectric array element is a photoelectric conversion array element or a light emitting array element.

Preferably, the body of the mounting holder further has two first contacting faces formed on two opposite second peripheral sides thereof individually, and at least one of the two first contacting faces decreasingly tilts from its top to its bottom. The lens element has two second contacting faces individually defined on two inner walls of the two slots and corresponding to the two first contacting faces of the mounting holder, wherein at least one of the two second contacting faces decreasingly slants from its top to its bottom so as to contact with the at least one first contacting face.

Preferably, the two first contacting faces tilt, and each of the two first contacting faces decreasingly tilts from its top to its bottom. The two second contacting faces of the lens element slants, and each of the two second contacting faces decreasingly slants from its top to its bottom so as to contact with each first contacting face.

### BRIEF DESCRIPTION OF THE DRAWINGS

FIG. 1 is a perspective view showing the assembly of a mounting holder according to a preferred embodiment of the present invention.

FIG. 2 is a perspective view showing the assembly of a fiber optic module according to the preferred embodiment of the present invention.

FIGS. 3 to 5 are a perspective view showing the operation of the mounting holder and the fiber optic module according to the preferred embodiment of the present invention.

FIG. 6 is a bottom plan view of a lens element of the fiber optic module according to the preferred embodiment of the present invention.

FIG. 7 is a front elevational view of the lens element of the fiber optic module according to the preferred embodiment of the present invention.

### DETAILED DESCRIPTION OF THE PREFERRED EMBODIMENTS

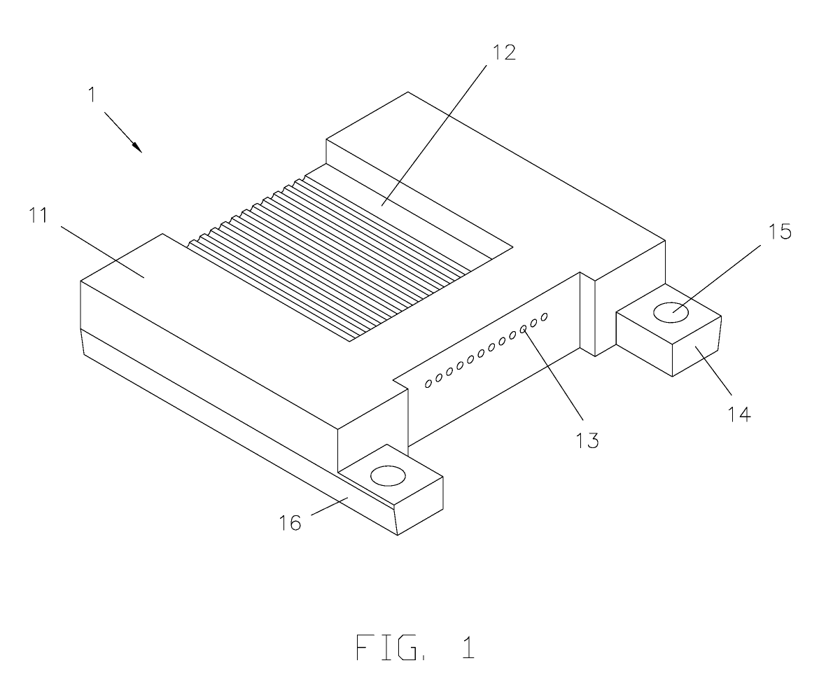

With reference to FIG. 1, a mounting holder 1 according to a preferred embodiment of the present invention includes: a body 11, an accommodation trench 12 defined on a top of the body 11, multiple orifices 13 arranged on a first peripheral side of the body 11 and communicating with the accommodation trench 12, two protrusions 14 extending outward from two ends of the first peripheral side of the body 11 respectively and adjacent to a bottom of the body 11, two first fixing holes 15 defined on the two protrusions 14 respectively, and two first contacting faces 16 formed on two opposite second peripheral sides of the body 11 individually, wherein each of the two first contacting faces 16 decreasingly tilts from its top to its bottom.

In another embodiment, the two first contacting faces 16 are flat or one of the two first contacting faces 16 is flat and the other first contacting face 16 is oblique. Preferably, the two first contacting faces 16 are oblique.

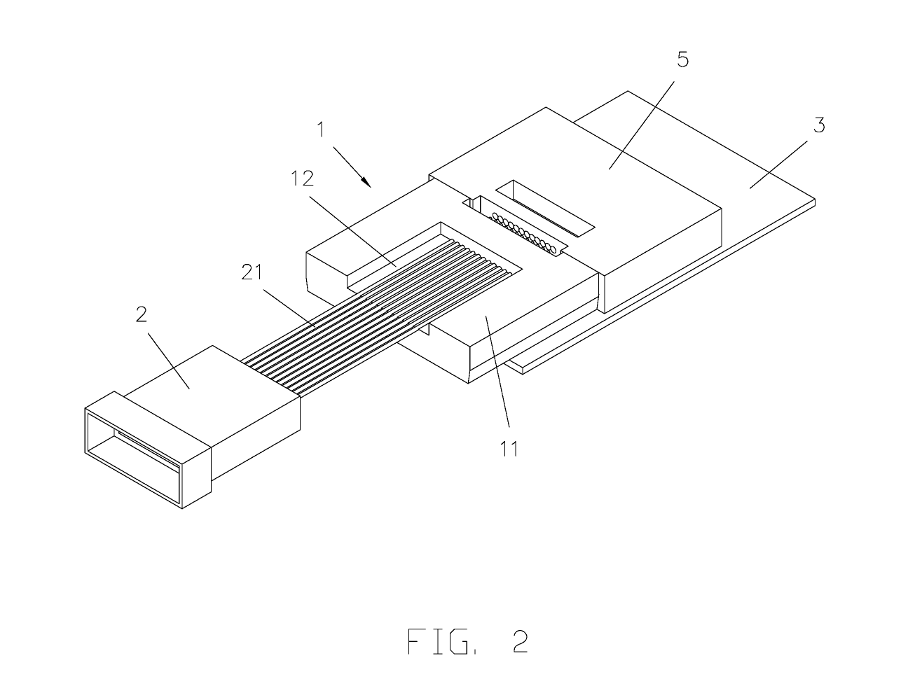

When the mounting holder 1 is connected into a fiber optic module, as shown in FIG. 2, a method of packaging the fiber optic module comprises steps of:

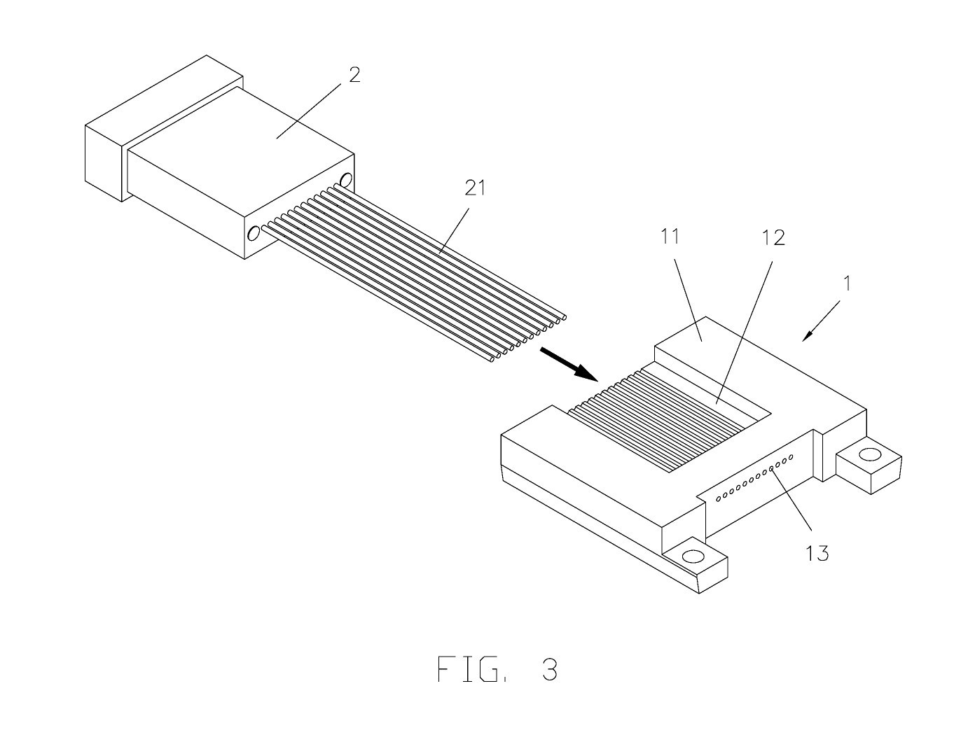

connecting a fiber optic connector 2 with the mounting holder 1, as illustrated in FIG. 3, wherein the fiber optic connector 2 includes multiple optical fiber cables 21 mounted on one end thereof and accommodated in the multiple orifices 13 respectively via the accommodation trench 12 of the mounting holder 1, and glue (not shown) is fed into the accommodation trench 12 so as to fix the multiple optical fiber cables 21 with the mounting holder 1, wherein one end of each of the multiple optical fiber cables 21 extends out of the mounting holder 1, the glue is UV glue, and when the glue is fed in the accommodation trench 12, it is irritated by UV lights so as to solidify and to secure the multiple optical fiber cables 21 in the accommodation trench 12;

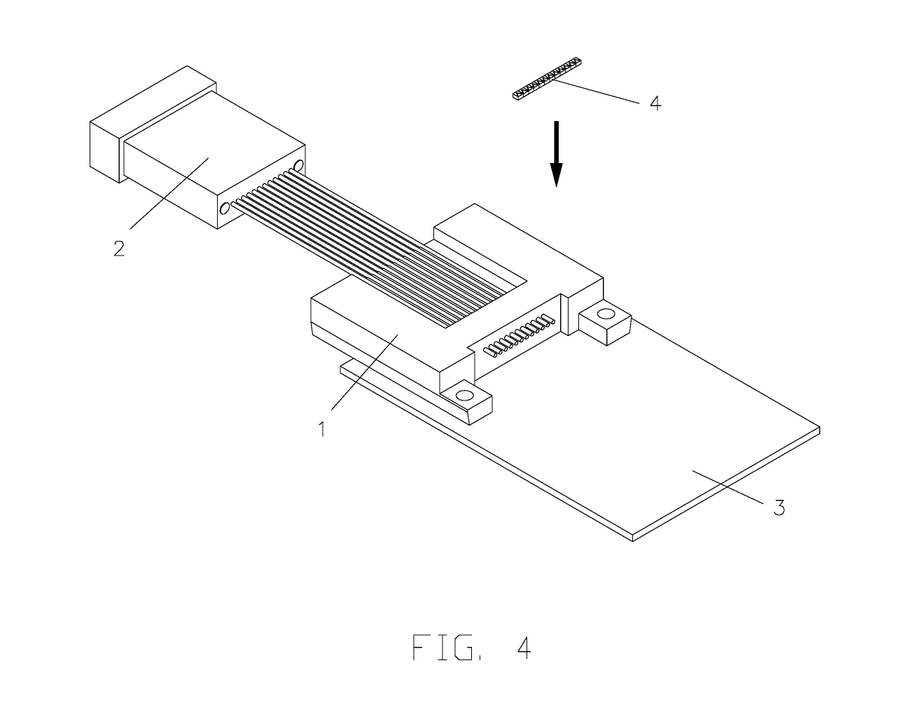

fixing the mounting holder 1 on a circuit board 3, as illustrated in FIG. 4, wherein the circuit board 3 includes two second fixing holes (not shown) corresponding to the two first fixing holes 15 so as to fix the mounting holder 1 on the circuit board 3;

mounting a photoelectric array element 4 on the circuit board 3, wherein the photoelectric array element 4 is mounted on the circuit board 3 opposite to the mounting holder 1, and the photoelectric array element 4 is a photoelectric conversion array element or a light emitting array element; and

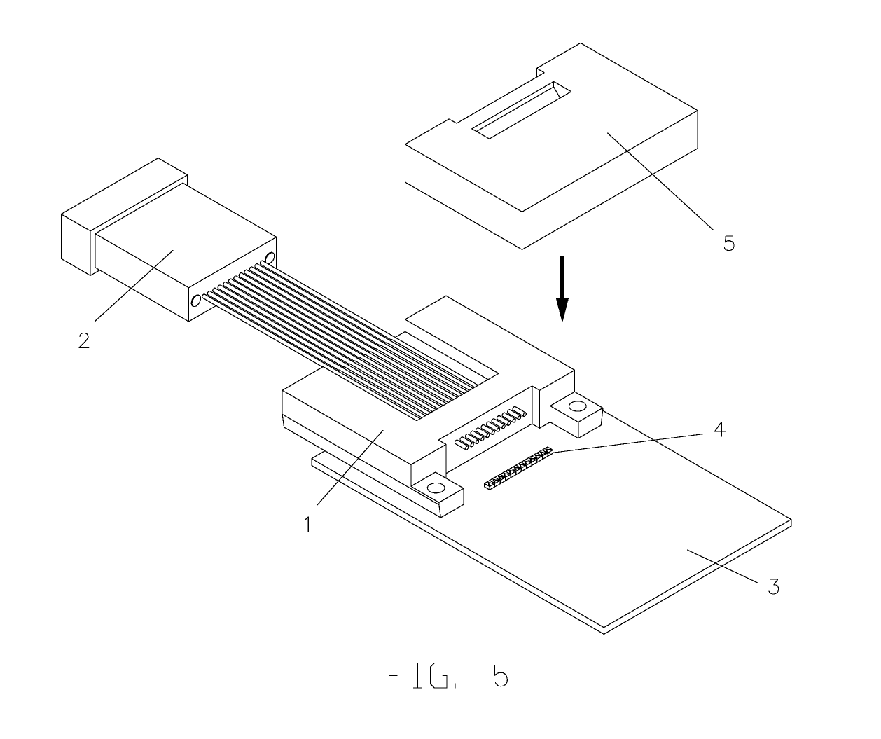

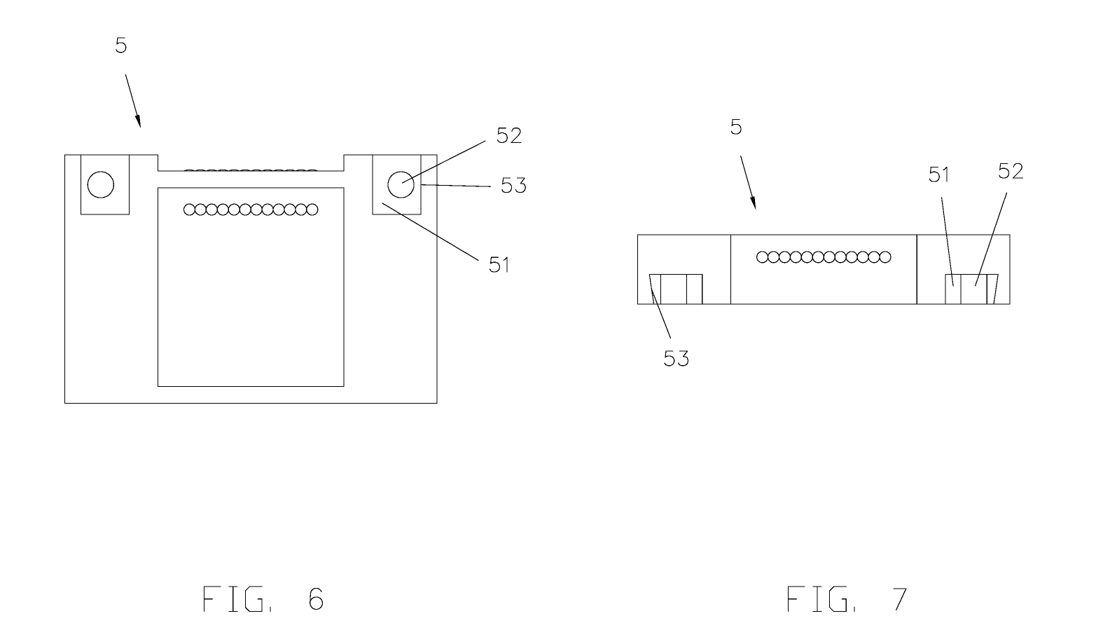

connecting a lens element 5 with the mounting holder 1, as shown in FIGS. 5-7, wherein the lens element 5 includes two slots 51 respectively formed on two sides thereof, two positioning columns 52 extending out of the two slots 51 respectively, two second contacting faces 53 individually defined on two inner walls of the two slots 51 and corresponding to the two first contacting faces 16 of the mounting holder 1, wherein each of the two second contacting faces 53 decreasingly slants from its top to its bottom so as to accommodate each of the two protrusions 14, and the two positioning columns 52 insert into the two first fixing holes 15 of the mounting holder 1 respectively, the two first contacting faces 16 of the mounting holder 1 matingly contact with the second contacting faces 53 of the lens element 5 individually, thus connecting the lens element 5 and the mounting holder 1 together. Referring to FIG. 2, the mounting holder 1, the fiber optic connector 2, the circuit board 3, and the lens element 5 are connected together.

In another embodiment, when the two first contacting faces 16 of the mounting holder 1 are flat, the two second contacting faces 53 of the lens element 5 are flat. In another embodiment, when one first contacting face 16 of the mounting holder 1 is flat and the other first contacting face 16 is oblique, one second contacting face 53 of the lens element 5 is flat and the other second contacting face 53 is oblique.

The accommodation trench 12 of the mounting holder 1 fixes the multiple optical fiber cables 21 so as to connect the fiber optic connector 2 with the mounting holder 1, the two protrusions 14 of the mounting holder 1 are housed in the two slots 51 of the lens element 5 individually, and the two positioning columns 52 of the lens element 5 insert into the two first fixing holes 15 of the mounting holder 1 respectively so as to limit the lens element 5 in a horizontal direction. Furthermore, each first contacting face 16 decreasingly tilts from its top to its bottom, and each second contacting face 53 decreasingly slants from its top to its bottom so that the lens element 5 and the mounting holder 1 are connected together in a vertical direction, thus connecting the mounting holder 1, the fiber optic connector 2, and the lens element 5 in the horizontal and vertical directions, decreasing packaging cost and time, reducing offset error among the multiple optical fiber cables, and enhancing coupling effect of the fiber optic module.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A mounting holder comprising a body, an accommodation trench defined on a top of the body, multiple orifices arranged on a first peripheral side of the body and communicating with the accommodation trench.

2. The mounting holder as claimed in claim 1, wherein The body has two protrusions extending outward from two ends of the first peripheral side thereof respectively and adjacent to a bottom of the body, and two first fixing holes are defined on the two protrusions respectively.

3. The mounting holder as claimed in claim 1, wherein the body further has two first contacting faces formed on two opposite second peripheral sides thereof individually, and at least one of the two first contacting faces decreasingly tilts from its top to its bottom.

4. The mounting holder as claimed in claim 3, wherein the two first contacting faces tilts, and each of the two first contacting faces decreasingly tilts from its top to its bottom.

5. A method of packaging a fiber optic module comprising steps of:
connecting a fiber optic connector with a mounting holder, wherein the mounting holder includes a body, an accommodation trench defined on a top of the body, multiple orifices arranged on a first peripheral side of the body and communicating with the accommodation trench, two protrusions extending outward from two ends of the first peripheral side of the body respectively and adjacent to a bottom of the body, and two first fixing holes defined on the two protrusions respectively, the fiber optic connector includes multiple optical fiber cables mounted on one end thereof and accommodated in the multiple orifices respectively via the accommodation trench of the mounting holder, and a glue is fed into the accommodation trench so as to fix the multiple optical fiber cables with the mounting holder, wherein one end of each of the multiple optical fiber cables extends out of the mounting holder;
fixing the mounting holder on a circuit board;
mounting a photoelectric array element on the circuit board, wherein the photoelectric array element is mounted on the circuit board opposite to the mounting holder; and
connecting a lens element with the mounting holder, wherein the lens element includes two slots respectively formed on two sides thereof, and the lens element includes two positioning columns extending out of the two slots respectively, the two slots respectively accommodate the two protrusions of the mounting holder, and the two positioning columns insert into the two first fixing holes of the mounting holder respectively.

6. The method as claimed in claim 5, wherein the glue is UV glue, and when the glue is fed in the accommodation trench, it is irritated by UV lights so as to solidify and to secure the multiple optical fiber cables in the accommodation trench.

7. The method as claimed in claim 5, wherein the circuit board includes two second fixing holes corresponding to the two first fixing holes respectively so as to fix the mounting holder on the circuit board.

8. The method as claimed in claim 5, wherein the photoelectric array element is a photoelectric conversion array element or a light emitting array element.

9. The method as claimed in claim 5, wherein the body of the mounting holder further has two first contacting faces formed on two opposite second peripheral sides thereof individually, and at least one of the two first contacting faces decreasingly tilts from its top to its bottom; and the lens element has two second contacting faces individually defined on two inner walls of the two slots and corresponding to the two first contacting faces of the mounting holder, wherein at least one of the two second contacting faces decreasingly slants from its top to its bottom so as to contact with the at least one first contacting face.

10. The method as claimed in claim 9, wherein the two first contacting faces tilt, and each of the two first contacting faces decreasingly tilts from its top to its bottom; the two second contacting faces of the lens element slants, and each of the two second contacting faces decreasingly slants from its top to its bottom so as to contact with each first contacting face.
